(19) United States
(12) Patent Application Publication
(10) Pub. No.: US 2026/0301286 A1
(43) Pub. Date: Oct. 1, 2026

(54) METHOD AND APPARATUS FOR GENERATING VIRTUAL EXPRESSION, ELECTRONIC DEVICE, AND STORAGE MEDIUM

(71) Applicant: BOE Technology Group Co., Ltd., Beijing (CN)

(72) Inventor: Tenghe CUI, Beijing (CN)

(21) Appl. No.: 18/992,522

(22) PCT Filed: Jul. 5, 2023
(86) PCT No.: PCT/CN2023/105870

§ 371 Date: Jan. 8, 2025

(30) Foreign Application Priority Data
Jul. 25, 2022 (CN) 202210878271.1

(51) Int. Cl. G06T 13/40; G06T 5/70; G06T 5/73; G06T 7/60; G06T 7/70; G06V 10/24; G06V 10/25; G06V 10/82; G06V 40/16

(52) U.S. Cl. CPC G06T 13/40; G06T 5/70; G06T 5/73; G06T 7/60; G06T 7/70; G06V 10/247; G06V 10/25; G06V 10/82; G06V 40/161; G06V 40/168; G06V 40/174; G06T 2207/10016; G06T 2207/20081; G06T 2207/20084; G06T 2207/30201; G06V 2201/07

(57) ABSTRACT

The present disclosure relates to a method and an apparatus for generating a virtual expression, an electronic device, and a storage medium. The method includes: obtaining a face region in an original image to obtain a target face image; obtaining a first face coefficient for the target face image; performing time-domain correction on the template expression coefficient and/or the pose coefficient of the first face coefficient, to obtain a target face coefficient; and according to the target face coefficient, rendering an expression of the virtual character, to obtain the virtual expression.

### TECHNICAL FIELD

The present disclosure relates to the field of data processing technology, in particular to a method and an apparatus for generating a virtual expression, an electronic device, and a storage medium.

### BACKGROUND

Three dimensional (3D) modeling is a key issue in the field of machine vision. 3D expression modeling is widely used in entertainment fields such as games, special effects, and VR. The current mainstream methods for 3D virtual expression modeling are based on images for generating 3D virtual expressions. However, since a facial structure is complex and involves coordinated movement of facial muscles, an expression change process is a complex non-rigid motion, which has high requirements for the collection device, the collection environment, the modeling device, and the modeling process, making it difficult to satisfy a real-time requirement, and moreover, when each image frame of the video is processed, the correlation and continuity of expressions are ignored.

### SUMMARY

The present disclosure provides a method and an apparatus for generating a virtual expression, an electronic device, and a storage medium, to address the shortcomings of related technologies.

According to the first aspect of the embodiments of the present disclosure, a method for generating a virtual expression is provided, and includes: obtaining a face region in an original image to obtain a target face image; obtaining a first face coefficient for the target face image, where the first face coefficient includes a template expression coefficient and a pose coefficient, where the template expression coefficient is used to represent a degree of matching between a facial expression and each of one or more templates, and the pose coefficient is used to represent a rotation angle of a virtual character in three dimensions; performing time-domain correction on the template expression coefficient and/or the pose coefficient of the first face coefficient, to obtain a target face coefficient; and according to the target face coefficient, rendering an expression of the virtual character, to obtain the virtual expression.

Optionally, obtaining the face region in the original image to obtain the target face image includes: performing face detection on the original image, to obtain one or more face regions in the original image; selecting a target face region from the one or more face regions; and correcting the target face region to obtain the target face image.

Optionally, selecting the target face region from the one or more face regions includes: in response to determining that there is one face region, determining the face region as the target face region; in response to determining that there are a plurality of face regions, for each of the plurality of face regions, calculating a score for the face region according to region parameter data of the face region, where the score is used to represent proximity of the face region to a medial axis of the original image; and determining a face region with a maximum score as the target face region.

Optionally, the region parameter data includes data of a length, a width, a face area, and a position, and for each of the plurality of face regions, calculating the score for the face region according to the region parameter data of the face region includes: for each of the plurality of face regions, obtaining a difference between a horizontal coordinate of a center of the face region and half of a width of the face region, and an absolute value of the difference; obtaining a ratio of the absolute value of the difference to the width, and a product of the ratio and a constant 2; obtaining a difference between a constant 1 and the product, and obtaining a product of the difference corresponding to the product and a preset distance weight; obtaining a ratio of a face area of the face region to a product of a length of the face region and a width of the face region, and a square root of the ratio corresponding to the face area; obtaining a product of the square root and a preset area weight, where a sum of the preset area weight and the preset distance weight is 1; and calculating a sum of the product corresponding to the preset area weight and the product corresponding to the preset distance weight, to obtain the score for the face region.

Optionally, correcting the target face region to obtain the target face image includes: determining a candidate square region corresponding to the target face region, to obtain vertex coordinate data of the candidate square region; performing affine transformation on the vertex coordinate data of the candidate square region and vertex coordinate data of a preset square, to obtain an affine transformation coefficient, where the vertex coordinate data of the preset square includes a designated origin; performing affine transformation on the original image by the affine transformation coefficient, to obtain an affine-transformed image; and extracting, by using the designated origin as a reference, a square region with a preset side length from the affine-transformed image, and determining an image in the square region as the target face image.

Optionally, obtaining the first face coefficient for the target face image includes: separately blurring and sharpening the target face image, to obtain one or more blurred images and one or more sharpened images; separately extracting feature data from the target face image, each of the one or more blurred images, and each of the one or more sharpened images, to obtain an original feature image, a blurred feature image, and a sharpened feature image; splicing the original feature image, the blurred feature image, and the sharpened feature image, to obtain an initial feature image; obtaining an importance coefficient of each of feature images in the initial feature image for presenting an expression of the virtual character, and according to the importance coefficient, adjusting the initial feature image, to obtain the target feature image; and according to the target feature image, determining the template expression coefficient and the pose coefficient, to obtain the first face coefficient.

Optionally, obtaining the first face coefficient for the target face image includes: inputting the target face image into a preset face coefficient recognition network, to obtain the first face coefficient for the target face image output by the preset face coefficient recognition network.

Optionally, the preset face coefficient recognition network includes: a blurring and sharpening module, a feature extracting module, an attention module, and a coefficient learning module; where the blurring and sharpening module is configured to respectively blur and sharpen the target face image, to obtain one or more blurred images and one or more sharpened images; the feature extracting module is configured to respectively extract feature data from the target face image, each of the one or more blurred images, and each of the one or more sharpened images, to obtain an original feature image, a blurred feature image, and a sharpened feature image; and concatenate the original feature image, the blurred feature image, and the sharpened feature image, to obtain an initial feature image; the attention module is configured to obtain an importance coefficient of each of feature images in the initial feature image for presenting an expression of the virtual character, and according to the importance coefficient, adjust the initial feature image, to obtain the target feature image; and the coefficient learning module is configured to determine, according to the target feature image, the template expression coefficient and the pose coefficient, to obtain the first face coefficient.

Optionally, the attention module is implemented by a network model of temporal attention mechanism or spatial attention mechanism.

Optionally, the coefficient learning module is implemented by one or more of: a Resnet50 network model, a Resnet18 network model, a Resnet100 network model, a DenseNet network model, or a YoloV5 network model.

Optionally, performing the time-domain correction on the template expression coefficient and/or the pose coefficient of the first face coefficient, to obtain the target face coefficient includes: obtaining a first face coefficient and a preset weight coefficient of a previous frame before the original image, where a sum of the preset weight coefficient of the previous frame and a preset weight coefficient of the original image is 1; and calculating a weighted sum of the first face coefficient of the original image and the first face coefficient of the previous frame, to obtain the target face coefficient for the original image.

Optionally, after performing the time-domain correction on the template expression coefficient and/or the pose coefficient of the first face coefficient, the method further includes: obtaining a preset expression adaptation matrix, where the expression adaptation matrix indicates a transformation relationship between two face coefficients containing different numbers of templates; and calculating a product of a time-domain corrected face coefficient and the preset expression adaptation matrix, to obtain the target face coefficient.

Optionally, the preset expression adaptation matrix is obtained by: obtaining a first preset coefficient corresponding to a sample image, where the first preset coefficient includes coefficients for a first number of templates; obtaining a second preset coefficient corresponding to a sample image, where the second preset coefficient includes coefficients for a second number of templates; and according to the first preset coefficient, the second preset coefficient, and least squares, obtaining the preset expression adaptation matrix.

Optionally, the method further includes: in response to determining that no face region is detected in the original image, continuing to detect a next original image, and according to the target face coefficient for the previous original image, obtaining the virtual expression; or, in response to determining that no face region is detected in the original image and a duration exceeds a set threshold, obtaining the virtual expression according to a preset expression coefficient.

According to the second aspect of the embodiments of the present disclosure, an apparatus for generating a virtual expression is provided, and includes: a target image obtaining module, configured to obtain a face region in an original image to obtain the target face image; a first coefficient obtaining module, configured to obtain a first face coefficient for the target face image, where the first face coefficient includes a template expression coefficient and a pose coefficient, where the template expression coefficient is used to represent a degree of matching between a facial expression and each of one or more templates, and the pose coefficient is used to represent a rotation angle of a virtual character in three dimensions; a target coefficient obtaining module, configured to perform time-domain correction on the template expression coefficient and/or the pose coefficient of the first face coefficient, to obtain a target face coefficient; and an expression animation obtaining module, configured to, according to the target face coefficient, render an expression of the virtual character, to obtain the virtual expression.

According to the third aspect of the embodiments of the present disclosure, an electronic device is provided, and includes: one or more processors; and one or more memories storing executable instructions; where the one or more processors read the executable instructions from the one or more memories to implement the method according to any one in the first aspect.

According to the fourth aspect of the embodiments of the present disclosure, a chip is provided, and includes: one or more processors; and one or more memories storing an executable program; where the one or more processors read the executable program from the one or more memories to implement the method according to any one in the first aspect.

According to the fifth aspect of the embodiments of the present disclosure, a non-transitory computer-readable storage medium is provided, where the storage medium stores a computer-executable program, where when the computer-executable program is executed, the method according to any one in the first aspect is implemented.

The technical solutions provided by the embodiments of the present disclosure can include following beneficial effects.

As can be seen from the above embodiments, in the solutions provided in embodiments of the present disclosure, the face region in the original image is obtained to obtain the target face image; then, the first face coefficient for the target face image is obtained; afterwards, time-domain correction is performed on the template expression coefficient and/or pose coefficient of the first face coefficient to obtain the target face coefficient; and finally, according to the target face coefficient, the expression of the virtual character is rendered to obtain the virtual expression. In this embodiment, by performing time-domain correction on the first face coefficient, the expressions of adjacent original images in the video can be correlated and continuous, making the reconstructed expressions more natural and improving the viewing experience. Moreover, the expression of the virtual character is rendered by transmitting the target face coefficient to obtain the virtual expression, which can, compared with transmitting image data, reduce the amount of data transmission and achieve the effect of real-time reconstruction of the virtual expression.

It is to be understood that the above general descriptions and the below detailed descriptions are merely exemplary and explanatory, and are not intended to limit the present disclosure.

### BRIEF DESCRIPTION OF DRAWINGS

Accompanying drawings herein are incorporated into and constitute a part of the specification, illustrate embodiments consistent with the present disclosure, and are combined with the description to explain the principle of the present disclosure.

FIG. 1 is a flowchart of a method for generating a virtual expression according to an embodiment.

FIG. 2 is a flowchart for obtaining a target face image according to an embodiment.

FIG. 3 is a flowchart for obtaining a target face region according to an embodiment.

FIG. 4 is a flowchart for obtaining a score for a face region according to an embodiment.

FIG. 5 is a flowchart for obtaining a target face image according to an embodiment.

FIG. 6 is a flowchart for obtaining a first face coefficient according to an embodiment.

FIG. 7 is a block diagram of a face coefficient recognition network according to an embodiment.

FIG. 8 is a flowchart for obtaining a target face coefficient according to an embodiment.

FIG. 9 is a flowchart for obtaining a target face coefficient according to an embodiment.

FIG. 10 is a flowchart for obtaining an expression adaptation matrix according to an embodiment.

FIG. 11 is a flowchart for obtaining an expression adaptation matrix according to an embodiment.

FIG. 12 is a flowchart of a method for generating a virtual expression according to an embodiment.

FIG. 13 is a block diagram of an apparatus for generating a virtual expression according to an embodiment.

FIG. 14 is a block diagram of a server according to an embodiment.

### DETAILED DESCRIPTION

Embodiments will be described in detail herein, examples of which are illustrated in the accompanying drawings. Where the following description refers to the drawings, elements with the same numerals in different drawings refer to the same or similar elements unless otherwise indicated. Embodiments described in the illustrative examples below are not intended to represent all embodiments consistent with the present disclosure. Rather, they are merely embodiments of devices consistent with some aspects of the present disclosure as recited in the appended claims. It should be noted that, without conflict, features in following embodiments can be combined with each other.

3D modeling is a key issue in the field of machine vision. 3D expression modeling is widely used in entertainment fields such as games, special effects, and VR. The current mainstream methods for 3D virtual expression modeling are based on images for generating 3D virtual expressions. However, since a facial structure is complex and involves coordinated movement of facial muscles, an expression change process is a complex non-rigid motion, which has high requirements for the collection device, the collection environment, the modeling device, and the modeling process, making it difficult to satisfy a real-time requirement, and moreover, when each image frame of the video is processed, the correlation and continuity of expressions are ignored.

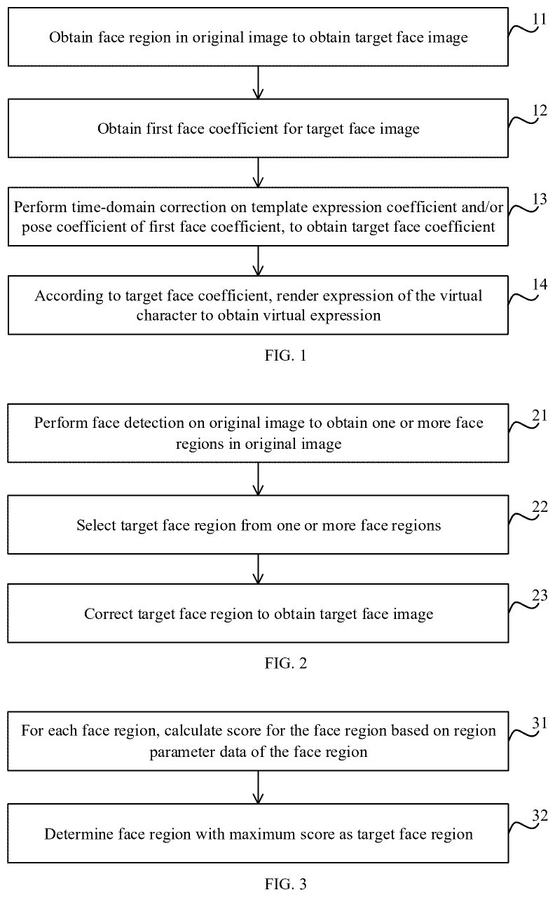

To address the above technical problems, embodiments of the present disclosure provide a method for generating a virtual expression. The method can be applied to an electronic device. FIG. 1 is a flowchart of a method for generating a virtual expression according to an embodiment.

Referring to FIG. 1, a method for generating a virtual expression includes steps 11 to 14.

In step 11, a face region in an original image is obtained to obtain a target face image.

In this embodiment, the electronic device can communicate with a camera to obtain images and/or videos captured by the camera, where a capture frame rate of the camera does not exceed 60 fps; and the electronic device can also read images and/or videos from specified location(s). Considering that the electronic device processes one image or one frame in a video at one time, the following describes the solutions of the embodiments by taking processing one image as an example, and the processing image is referred to as the original image to distinguish the processing image from other processed images.

In this embodiment, after the original image is obtained, the electronic device can obtain the face region in the original image, as shown in FIG. 2, including steps 21 to 23.

In step 21, the electronic device can perform face detection on the original image to obtain one or more face regions in the original image.

In this step, the electronic device can use a preset face detection model to perform face detection on the original image. The preset face detection model can include but be not limited to a yolov5 model, a resnet18 model, an R-CNN model, a mobilenet model, or other models that can achieve an object detection function. Those skilled in the art can choose an appropriate model according to a specific scenario, and corresponding solutions fall within the protection scope of the present disclosure. In this way, the preset face detection model mentioned above can output one or more face regions contained in the original image.

It should be noted that during the face detection process, the electronic device can record whether a face region has been detected. When there is no face region, a label can be set to −1. When there is one or more face regions, the label can be set to the number of the one or more face regions, and region parameter data of each face region can be recorded. The region parameter data includes data of a length, a width, a face area, and a position.

For example, when the number of the face regions is 1, the region parameter data of the face region is [x, y, w, h, s], where x and y represent the horizontal and vertical coordinates of a designated point in the face region (such as the center point, the upper left vertex, the lower left vertex, the upper right vertex, or the lower right vertex), w and h represent the width and height of the face region, and s represents the area of the face region. For example, when the number of face regions is n1 (n1 is an integer greater than 1), the region parameter data of n1 face regions is represented in a list, i.e., [x1, y1, w1, h1, s1], [x2, y2, w2, h2, s2], . . . , [xn1, yn1, wn1, hn1, sn1]].

In step 22, the electronic device can select a target face region from the one or more face regions.

For example, when the number of face regions is 1, the electronic device can determine that the face region is the target face region.

For example, when there are a plurality of face regions (such as n1 face regions, where n1 is an integer greater than 1), the electronic device can select one of the plurality of face regions as the target face region. Referring to FIG. 3, in step 31, for each face region, the electronic device can calculate a score for the face region based on the region parameter data of the face region. The score for each face region is used to represent proximity of the face region to a medial axis of the original image. The medial axis of the original image refers to a vertical line passing through the center point of the original image. If the size of the original image is 1920*1080, then the line x=960 can be used as the medial axis of the original image.

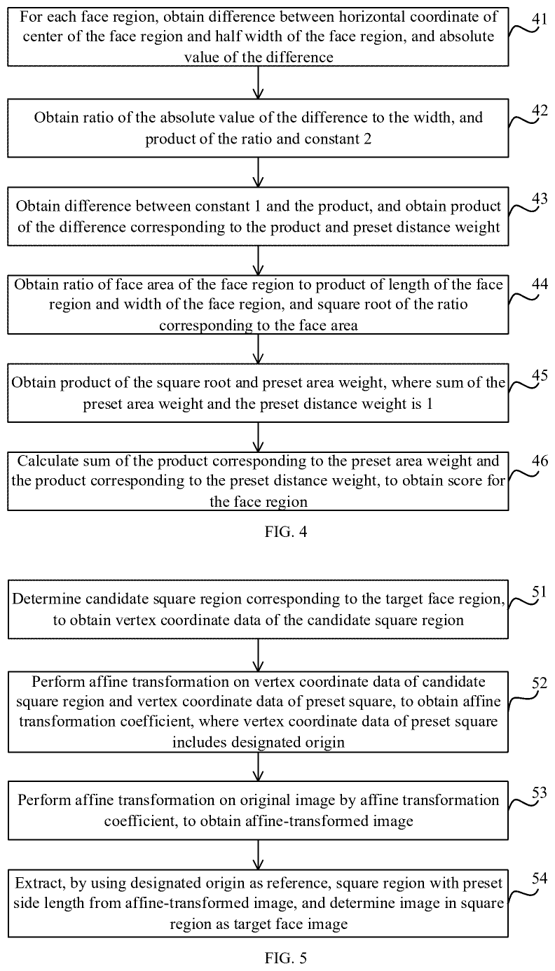

In this example, as shown in FIG. 4, obtaining, by the electronic device, the score for each face region includes steps 41 to 46.

In step 41, for each face region, the electronic device can obtain a difference between the horizontal coordinate of the center of the face region and half the width of the face region, and the absolute value of the difference. For example, the absolute value of the difference is

$$\vert {x}_{n 1} - \frac{w}{2} \vert ,$$

where xn1 represents the horizontal coordinate of the n1^{-th} face region, w represents the width of the n1^{-th} face region, and ∥ represents calculating the absolute value.

In step 42, the electronic device can obtain a ratio of the absolute value of the difference to the width, and a product of the ratio and a constant 2. For example, the product of the ratio and the constant 2 is

$$\frac{2 \vert {x}_{n 1} - \frac{w}{2} \vert}{w} .$$

In step 43, the electronic device can obtain a difference between a constant 1 and the product, and obtain a product of the difference corresponding to the product and a preset distance weight. For example, the product of the difference corresponding to the product and the preset distance weight is

$$α * ( 1 - \frac{2 \vert {x}_{n 1} - \frac{w}{2} \vert}{w} ) ,$$

where α represents the preset distance weight, or a normalized value of the distance between the center of the face region and the medial axis, and α is affected by the capturing distance of the camera. In an example, α is 0.2.

In step 44, the electronic device can obtain a ratio of a face area of the face region to a product of a length of the face region and a width of the face region, and a square root of the ratio corresponding to the face area. For example,

$$\frac{{s}_{n 1}}{h * w} ,$$

where Sₙ₁ represents the face area in the n1^{-th} face region, h represents the height of the n1^{-th} face region, and w represents the width of the n1^{-th} face region.

In step 45, the electronic device can obtain a product of the square root and a preset area weight, where a sum of the preset area weight and the preset distance weight is 1. For example, the product of the square root and the preset area weight is

$$( 1 - α ) * \sqrt{\frac{{s}_{n 1}}{h * w}} ,$$

where 1-α represents a normalized value of the face area to the original image area.

In step 46, the electronic device can calculate a sum of the product corresponding to the preset area weight and the product corresponding to the preset distance weight, to obtain the score for the face region. For example, for each face region, the score for the face region is shown in formula (1):

$$score = α * ( 1 - \frac{2 \vert {x}_{n 1} - \frac{w}{2} \vert}{w} ) + ( 1 - α ) * \sqrt{\frac{{s}_{n 1}}{h * w}} \qquad ( 1 )$$

In step 32, the electronic device can determine a face region with a maximum score as the target face region.

In this example, by determining the face region with the maximum score as the target face region, the face region closest to the medial axis of the original image and with a larger face area can be determined, which is more consistent with a scenario of the target object in the capturing region during an actual image capturing process, and is beneficial for improving the accuracy of the obtained target face region.

In step 23, the electronic device can correct the target face region to obtain the target face image.

In this step, as shown in FIG. 5, correcting, by the electronic device, the target face region includes steps 51 to 54.

In step 51, the electronic device can determine a candidate square region corresponding to the target face region, to obtain vertex coordinate data of the candidate square region. The electronic device can obtain a center point (xₙ₁, yₙ₁) of the target face region and determine a square region by taking the center point (xₙ₁, yₙ₁) as a center. The side length of the square region is

$$\frac{scale * ( {w}_{n 1} + {h}_{n 1} )}{2} ,$$

where scale represents an enlargement factor for the target face region, which is greater than 1. In an example, the scale is 1.25. wₙ₁, hₙ₁ respectively represent the width and height of the target face region. The electronic device can obtain vertex coordinate data of vertices of the square region. For the convenience of description, the above square region will be referred to as a candidate square region in the following.

In step 52, the electronic device can perform affine transformation on the vertex coordinate data of the candidate square region and vertex coordinate data of a preset square, to obtain an affine transformation coefficient, where the vertex coordinate data of the preset square includes a designated origin.

In this step, the electronic device can store a preset square. The vertex coordinate data of the preset square includes a designated origin (0,0), and a side length of the preset square is a preset side length (such as 224 pixels). Taking the top left vertex as the designated origin, the vertex coordinate data of the four vertices of the preset square are respectively the top left vertex (0, 0), the bottom left vertex (0, 224), the top right vertex (224, 0), and the bottom right vertex (224, 224).

In this step, the electronic device can perform affine transformation on the candidate square region and the preset square, that is, establish an affine transformation relationship between the vertices of the candidate square region and the vertices of the preset square, to obtain an affine transformation coefficient. Alternatively, the electronic device can scale, translate, and rotate the candidate square region to obtain the preset square. It is understandable that obtaining the affine transformation relationship between two squares can refer to the relevant technical solutions, which will not be elaborated here.

In step 53, the electronic device can perform affine transformation on the original image by the affine transformation coefficient, to obtain an affine-transformed image.

In step 54, the electronic device can extract, by using the designated origin as a reference, a square region with a preset side length from the affine-transformed image, and determine an image in the square region as the target face image. For example, the electronic device extracts a square with a length of 224 pixels and a width of 224 pixels from the affine-transformed image at the position (0,0) to obtain the target face image.

In this example, by performing the affine transformation correction on the target face region, compared with stretching or squeezing the face region, the face region can have better fidelity, that is, the facial expression can have better fidelity, which is conducive to improving the accuracy of the virtual expression generated subsequently. Alternatively, in this example, processing the original image as a high-fidelity normalized target face image can improve the accuracy of the first face coefficient in the subsequent step 12, and improve the degree of truth and realism of the virtual expression generated in step 14, which is beneficial for enhancing the interactive experience.

In step 12, a first face coefficient for the target face image is obtained, where the first face coefficient includes a template expression coefficient and a pose coefficient, where the template expression coefficient is used to represent a degree of matching between a facial expression and each of one or more templates, and the pose coefficient is used to represent a rotation angle of a virtual character in three dimensions.

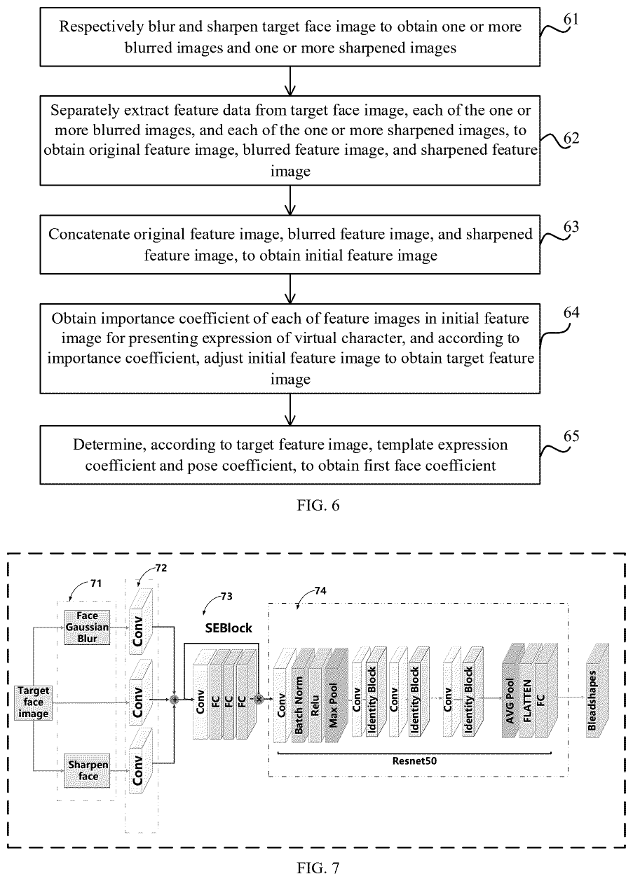

In this step, obtaining, by the electronic device, the first face coefficient corresponding to the target face image, as shown in FIG. 6, includes steps 61 to 65.

In step 61, the electronic device can respectively blur and sharpen the target face image, to obtain one or more blurred images and one or more sharpened images.

Considering that the target face image is a part of the original image and the features of the target face image are not prominent, in this step, the overall features and/or detailed features of the target face image are first extracted.

Taking obtaining overall contour features as an example, in this step, the electronic device can blur the target face image. The blurring algorithm used can include but are not limited to Gaussian Blur, Box Blur, Kawase Blur, Dual Blur, Bokeh Blur, Tilt Shift Blur, Iris Blur, Grainy Blur, Radial Blur, or Directional Blur. In an example, the Gaussian Blur algorithm is used to process the target face image to obtain one or more blurred images corresponding to the target face image.

Taking obtaining detailed contour features as an example, in this step, the electronic device can sharpen the target face image. The sharpening algorithm used can include but are not limited to Robert operator, Prewitt operator, Sobel operator, Laplacian operator, or Kirsch operator. In an example, the Robert operator is used to process the target face image to obtain one or more sharpened images corresponding to the target face image.

In some examples, the aforementioned blurring algorithm and/or sharpening algorithm can also be implemented using a neural network (such as convolutional neural network, etc.) in the machine vision field, to obtain blurred images and/or sharpened images, and the corresponding solutions fall within the scope of protection of the present disclosure.

In this step, by blurring and sharpening the target face image, the overall contour features, detailed contour features, and original features of the target face image can be used, thereby enriching the number and categories of features in the target face image and improving the accuracy of obtaining the first face coefficient subsequently.

In step 62, the electronic device can separately extract feature data from the target face image, each of the one or more blurred images, and each of the one or more sharpened images, to obtain an original feature image, a blurred feature image, and a sharpened feature image. For example, the electronic device can perform one or more convolutional operations on the target face image, each blurred image, and each sharpened image to obtain the original feature image, the blurred feature image, and the sharpened feature image.

In step 63, the electronic device can concatenate the original feature image, the blurred feature image, and the sharpened feature image, to obtain an initial feature image. For example, the electronic device can concatenate the blurred feature image behind the original feature image, and after the blurred feature image is concatenated, concatenate the sharpened feature image behind the blurred feature image. Until all the feature images are concatenated, a feature image (hereinafter referred to as the initial feature image) with blurred features, original features, and sharpened features is obtained.

In step 64, the electronic device can obtain an importance coefficient of each of feature images in the initial feature image for presenting an expression of the virtual character, and according to the importance coefficient, adjust the initial feature image, to obtain the target feature image. For example, the electronic device can obtain the importance coefficient of each of feature images in the initial feature image for presenting an expression of the virtual character through a temporal attention mechanism and/or a spatial attention mechanism. Then, the electronic device can calculate the product of the above importance coefficient and the initial feature image to obtain the target feature image.

In this step, by adjusting the initial feature image through the importance coefficient, the relatively important feature image can be emphasized, and the relatively unimportant feature image can be weakened, improving the accuracy of the target feature image, and thus improving the accuracy of the first face coefficient obtained in step 65.

In step 65, the electronic device can determine, according to the target feature image, the template expression coefficient and the pose coefficient, to obtain the first face coefficient.

In this step, the electronic device can store a preset set of expression templates, and each of the expression templates is referred to as an expression base. The electronic device can determine a matching degree between the target feature image and each of the expression bases, thereby determining the template expression coefficient and the pose coefficient, to obtain the first face coefficient mentioned above. Alternatively, the expression bases are adjusted by the template expression coefficient of the first face coefficient, and the spatial pose of each expression base is adjusted by the pose coefficient, such that the target feature image can be reconstructed.

In another embodiment, the electronic device can store a preset face coefficient recognition network. The electronic device can input the target face image into a preset face coefficient recognition network, and the preset face coefficient recognition network outputs the first face coefficient for the target face image.

Referring to FIG. 7, the preset face coefficient recognition network includes: a blurring and sharpening module 71, a feature extracting module 72, an attention module 73, and a coefficient learning module 74. The blurring and sharpening module 71 is configured to respectively blur and sharpen the target face image, to obtain one or more blurred images and one or more sharpened images; the feature extracting module 72 is configured to respectively extract feature data from the target face image, each of the one or more blurred images, and each of the one or more sharpened images, to obtain an original feature image, a blurred feature image, and a sharpened feature image, and concatenate the original feature image, the blurred feature image, and the sharpened feature image, to obtain an initial feature image; the attention module 73 is configured to obtain an importance coefficient of each of feature images in the initial feature image for presenting an expression of the virtual character, and according to the importance coefficient, adjust the initial feature image, to obtain the target feature image, where the attention module is implemented by a network model of temporal attention mechanism or spatial attention mechanism.

The coefficient learning module 74 is configured to determine, according to the target feature image, the template expression coefficient and the pose coefficient, to obtain the first face coefficient The coefficient learning module is implemented by one or more of: a Resnet50 network model, a Resnet18 network model, a Resnet100 network model, a DenseNet network model, or a YoloV5 network model, which can be selected by those skilled in the art according to specific scenarios, and the corresponding solutions fall within the scope of protection of the present disclosure.

In step 13, time-domain correction is performed on the template expression coefficient and/or the pose coefficient of the first face coefficient, to obtain a target face coefficient, where the target face coefficient is associated with a face coefficient for a previous original image before the original image; and

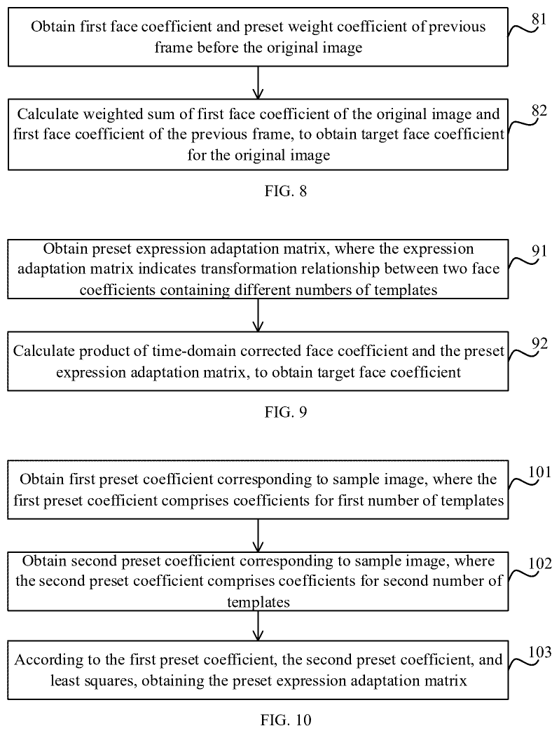

In this step, as shown in FIG. 8, performing, by the electronic device, the time-domain correction on the template expression coefficient and/or the pose coefficient in the first face coefficient to obtain the target face coefficient can include steps 81 to 82.

In step 81, the electronic device can obtain a first face coefficient and a preset weight coefficient of a previous frame before the original image, where a sum of the preset weight coefficient of the previous frame and a preset weight coefficient of the original image is 1.

In step 82, the electronic device can calculate a weighted sum of the first face coefficient of the original image and the first face coefficient of the previous frame, to obtain the target face coefficient for the original image.

In this embodiment, the target face coefficient is obtained by a weighted sum, which can establish a correlation relationship between the face coefficient of the current original image and the face coefficient of the previous frame. The larger the preset weight coefficient of the previous frame, the greater the proportion of the face coefficient of the previous frame in the target face coefficient, the smoother the parameter changes between the previous frame and the current original image, and the slower the virtual expression changes between the current original image and the previous frame. The smaller the preset weight coefficient of the previous frame, the faster the parameter changes between the previous frame and the current original image, and the faster the virtual expression changes between the current original image and the previous frame. Those skilled in the art can choose an appropriate preset weight coefficient based on a specific scenario, so that the expression changes of adjacent two original images meet the needs of the scenario. In an example, the preset weight coefficient of the previous frame is 0.4, and the weight coefficient of the current original image is 0.6.

It should be noted that when the current original image is the first frame of the video, and there is no previous frame, the electronic device can directly use the first face coefficient of the first frame as the target face coefficient, that is, the time-domain correction is not performed on the first face coefficient, which ensures the accuracy of the expression of the first frame.

Considering the template used in step 65 and/or the coefficient learning module 74 for obtaining the first face coefficient.

In the method for generating a virtual expression provided in the present disclosure, the set of expression templates can be fixed, “fixed” means but not limited to that templates in the set are fixed and the number of templates in the set is fixed. Considering that different electronic devices may use different sets of expression templates, it is necessary to adapt the first face coefficients obtained by different electronic devices, such as adapting 64 expression templates to 52 expression templates. Referring to FIG. 9, the electronic device adapts the first face coefficient, including steps 91 to 92.

In step 91, the electronic device can obtain a preset expression adaptation matrix, where the expression adaptation matrix indicates a transformation relationship between two face coefficients containing different numbers of templates.

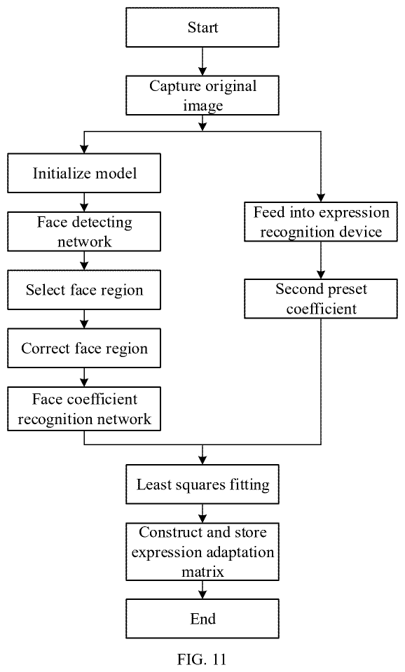

In this step, the electronic device can store a preset expression adaptation matrix. The preset expression adaptation matrix can be obtained through the following steps, as shown in FIGS. 10 and 11, including steps 101 to 103.

In step 101, the electronic device can obtain the first preset coefficient corresponding to a sample image. The acquisition method can be found in the embodiments shown in FIG. 6 or FIG. 7, and will not be further elaborated here. The first preset coefficient mentioned above includes the coefficients for the first number (such as 64) of templates, which indicates the matching degree of the sample image to each template (or expression base) in the first number of templates.

In step 102, the electronic device can a second preset coefficient corresponding to a sample image, where the second preset coefficient includes coefficients for a second number of templates. The acquisition method can be found in the embodiments shown in FIG. 6 or FIG. 7, and will not be further elaborated here. The second preset coefficient mentioned above includes the coefficients of the second number (such as 52) of templates, which indicates the matching degree of the sample image to each template (or expression base) in the second number of templates.

In step 103, the electronic device can obtain, according to the first preset coefficient, the second preset coefficient, and least squares, the preset expression adaptation matrix.

In this step, the first preset coefficient is \vec{a}_{basic}, the second preset coefficient is \vec{a}_{new}, and the \vec{a}_{new} and the [\vec{a}_{basic}, 1] have a linear relationship

$${\vec{a}}_{new} = S * [ \begin{matrix}{\vec{a}}_{basic} \\ 1\end{matrix} ] , \qquad ( 2 )$$

The sum of a square of a difference between the first preset coefficient and the second preset coefficient should be minimized as much as possible, as shown in formula (3):

$$J = {\sum }_{i = 1}^{m} {( S * [ \begin{matrix}{\vec{a}}_{basic}^{i} \\ 1\end{matrix} ] - {\vec{a}}_{new}^{i} )}^{2} \qquad ( 3 )$$

In formula (3), J represents the loss of the sum of the square, S∈R^{k×(j+1)} represents the expression adaptation matrix, k represents the number (i.e., the second number) of new expression bases, and j represents the number (i.e., the first number) of basic expression bases.

By calculating formula (3), S can be obtained, as shown in formula (4):

$$S = {{( [ \begin{matrix}{\vec{a}}_{basic} \\ 1\end{matrix} ] [ \begin{matrix}{\vec{a}}_{basic} \\ 1\end{matrix} ] )}^{- 1} [ \begin{matrix}{\vec{a}}_{basic} \\ 1\end{matrix} ]}^{T} {\vec{a}}_{new} \qquad ( 4 )$$

It should be noted that the first preset coefficient and the second preset coefficient have a linear relationship and are obtained through the following methods. The analysis is as follows: in this step, adjusting the first preset coefficient can be divided into an adjustment for the template expression coefficient and an adjustment for the pose coefficient. Considering that the pose coefficient has spatial physical significance, the adjustment for the pose coefficient only related to a transformation of different dimensions or different coordinate systems in space, such as the conversion of radians and angles, and adaptation for clockwise and counterclockwise directions, etc. This part of the content can refer to the transformation solutions in relevant technologies, and will not be elaborated here. Therefore, in this step, adjusting the first preset coefficient refers to adjusting the template expression coefficient.

It is understandable that the representation of the facial expression in the spatial dimension can be seen as a shape attribute of a spatial geometry enclosed by multiple discrete vertices, as shown in formula (5):

$$F = * ( {x}_{1} , {y}_{1} , {z}_{1} ) , ( {x}_{2} , {y}_{2} , {z}_{2} ) , … , ( {x}_{i} , {y}_{i} , {z}_{i} ) , … , ( {x}_{m 1} , {y}_{m 1} , {z}_{m 1} ) ) \qquad ( 5 )$$

In formula (5), m1 represents the number of discrete vertices that constitute the face, and (xᵢ, yᵢ, zᵢ) represents the spatial coordinate data of the i-th vertex.

When there are too many discrete vertices required to depict the facial expression, the electronic device has a high computational load, which is not conducive to generating animations. In this step, the electronic device can use Principal Component Analysis (PCA) for dimensionality reduction to drive high-dimensional models by the motion of low dimensional discrete vertices. After PCA processing, a matrix of a feature vector can be obtained, which is the set of principal components. The principal components in the set are orthogonal to each other, and each principal component serves as an expression basis. Therefore, the 3D facial expression is a linear combination of a natural expression and a set of expression bases, as shown in formula (6):

$$F = \vec{F} + P \vec{a} \qquad ( 6 )$$

In formula (6), \vec{F} represents the natural expression, that is, a face without any expression or an initial face. P∈R^{n×m} is a matrix composed of m feature vectors, and one feature vector is a blendshape in an application process. P represents a set of blendshapes. \vec{a}=(a₁, a₂, . . . , aₘ)^{T}∈R^{m} represents the coefficient of the expression feature vector, such as the first preset coefficient or the first face coefficient.

An expression space, i.e., the facial expression, can be represented by different natural expressions and different feature vectors, as shown in formula (7):

$$F = \vec{{F}_{b a s i c}} + {P}_{b a s i c} \vec{{a}_{b a s i c}} = \vec{{F}_{n e w}} + {P}_{new} \vec{{a}_{n e w}} \qquad ( 7 )$$

In formula (7), basic and new respectively represent the basic expression base space and the new expression base space, P_{basic}∈R^{n×j}, P_{new}∈R^{n×k}, \vec{a}_{new}∈R^{j}, \vec{a}_{basic}∈R^{k}.

By transforming formula (7), formula (8) can be obtained:

$$F = \vec{{F}_{b a s i c}} + {P}_{new} C * \vec{{a}_{b a s i c}} \qquad ( 8 )$$

In formula (8), C∈R^{k×j} represents the mapping function between the basic expression base and the new expression base.

By transforming formula (8), formula (9) can be obtained:

$$\vec{{F}_{b a s i c}} = \vec{{F}_{new}} + {P}_{new} * \vec{{a}_{p}} \qquad ( 9 )$$

In formula (9), \vec{a}ₚ∈R^{k×1} represents the coefficient of the difference feature vector. According to formulas (8) and (9), formulas (10) and (11) can be obtained:

$$F = \vec{{F}_{n e w}} + {P}_{new} * \vec{{a}_{p}} + {P}_{new} C * \vec{{a}_{basic}} \qquad ( 10 )$$

$$F = \vec{{F}_{n e w}} + {P}_{new} [ C , \vec{{a}_{p}} ] * [ \begin{matrix}{\vec{a}}_{basic} \\ 1\end{matrix} ] \qquad ( 11 )$$

By combining formulas (7) and (11), formula (2) can be obtained:

$${\vec{a}}_{n e w} = S * [ \begin{matrix}{\vec{a}}_{basic} \\ 1\end{matrix} ] \qquad ( 2 )$$

In step 92, the electronic device can calculate a product of a time-domain corrected face coefficient and the preset expression adaptation matrix, to obtain the target face coefficient. In this step, the target face coefficient is a modified coefficient, which achieves the transformation from different expression bases to other expression bases, to match the target face coefficient with the corresponding expression base and achieve the effect of expression transfer.

In step 14, according to the target face coefficient, an expression of the virtual character is rendered, to obtain the virtual expression.

In this step, the electronic device can use the target face coefficient to render the expression of the virtual character. For example, the electronic device can transmit the target face coefficient through UDP (User Datagram Protocol) broadcasting, and then a preset rendering program (such as a Unity program) will render the image when receiving the UDP data. Finally, a 3D display displays the virtual expression of the virtual character in real time.

In an embodiment, when no face region is detected in the original image, the electronic device can render the expression of the virtual character based on the target face coefficient of the previous original image before the original image to obtain the virtual expression, which makes the expression of the virtual character in adjacent two frames of original images correlated and continuous. Moreover, the electronic device can continue to detect the next frame of the original image by repeating step 11.

In another embodiment, the electronic device may initiate timing (or counting) when no face region is detected in the original image. When the duration of the timing exceeds the set threshold (such as 3-5 seconds) and the electronic device still cannot detect the face region, a virtual expression is obtained based on the preset expression coefficient, to display the initial expression of the virtual character. Moreover, the electronic device can also reduce the frequency of face detection to save processing resources, such as detecting the face region every 3-5 frames of the original images until the face region is detected again, and then detecting the face region once per frame of the original image.

Therefore, in the solutions provided in embodiments of the present disclosure, the face region in the original image is obtained to obtain the target face image; then, the first face coefficient for the target face image is obtained; afterwards, time-domain correction is performed on the template expression coefficient and/or pose coefficient of the first face coefficient to obtain the target face coefficient; and finally, according to the target face coefficient, the expression of the virtual character is rendered to obtain the virtual expression. In this embodiment, by performing time-domain correction on the first face coefficient, the expressions of adjacent original images in the video can be correlated and continuous, making the reconstructed expressions more natural and improving the viewing experience. Moreover, the expression of the virtual character is rendered by transmitting the target face coefficient to obtain the virtual expression, which can, compared with transmitting image data, reduce the amount of data transmission and achieve the effect of real-time reconstruction of the virtual expression.

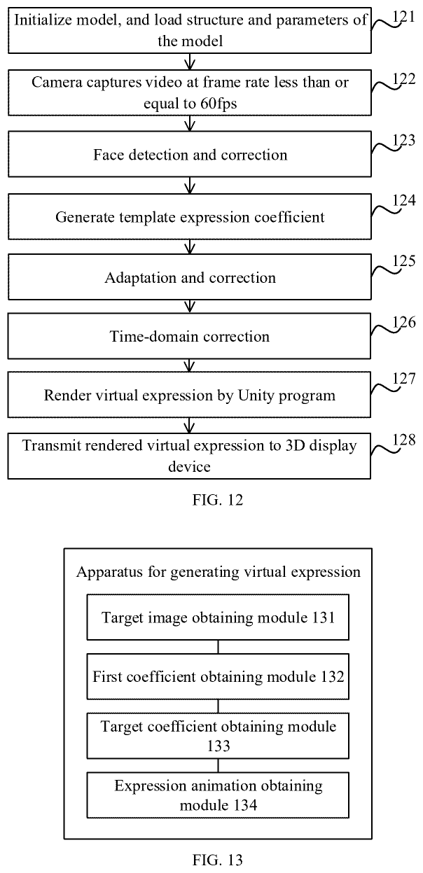

The embodiments of the present disclosure provide a method for generating a virtual expression, as shown in FIG. 12, including steps 121 to 128.

In step 121, a model is initialized, and a structure and parameters of the model are loaded.

In step 122, the camera captures the video at a frame rate less than or equal to 60 fps.

In step 123, face detection and correction are performed. That is, all face regions in the video frame (i.e. the original image) are obtained by a preset face detection model; and an optimal face is selected based on the weighted values of the face size and the center position of the face, and the optimal face is modified to obtain a 224*224 pixel face image to meet the input requirements of the face coefficient recognition network.

In step 124, the template expression coefficient is generated. That is, the 224*224-pixel face image obtained in step 123 is fed into the face coefficient recognition network to obtain the first face coefficient, where the first face coefficient is used to describe the facial expression and pose.

In step 125, adaptation and correction are performed. That is, the coefficient for the basic expression bases is mapped to the coefficient for new expression bases and the pose coefficient is transformed. The coefficient for new expression bases can be regarded as a linear combination of the coefficient for basic expression bases, so this process is only one matrix multiplication in the overall implementation process. The pose coefficient has a clear physical significance, and a template pose can be changed according to the actual physical significance.

In step 126, time-domain correction is performed. That is, the facial expression has the temporal correlation, rather than independent expression reconstruction for each frame. Therefore, the time-domain correction of the expression coefficient and the pose coefficient is introduced to smooth the process of facial expression transformation and improve the continuity and stability of 3D virtual expressions.

In step 127, the virtual expression is rendered by the Unity program. That is, the processed expression coefficient and pose coefficient, i.e. the target face coefficient, are then transmitted into the Unity program through a UDP port to drive the motion of the established virtual expression.

In step 128, the rendered virtual expression is transmitted to the 3D display device. the 3D display device is used to view the 3D virtual expression, and then steps 122-127 are repeated to achieve real-time interaction of the 3D virtual expression.

Based on the method for generating a virtual expression provided in the embodiments of the present disclosure, an apparatus for generating a virtual expression is further provided, as shown in FIG. 13, and includes: a target image obtaining module 131, configured to obtain a face region in an original image to obtain a target face image; a first coefficient obtaining module 132, configured to obtain a first face coefficient for the target face image, where the first face coefficient includes a template expression coefficient and a pose coefficient, where the template expression coefficient is used to represent a degree of matching between a facial expression and each of one or more templates, and the pose coefficient is used to represent a rotation angle of a virtual character in three dimensions; a target coefficient obtaining module 133, configured to perform time-domain correction on the template expression coefficient and/or the pose coefficient of the first face coefficient, to obtain a target face coefficient; and an expression animation obtaining module 134, configured to, according to the target face coefficient, render an expression of the virtual character, to obtain the virtual expression.

In an embodiment, the target image obtaining module includes: a face region obtaining submodule, configured to perform face detection on the original image, to obtain one or more face regions in the original image; a target region obtaining submodule, configured to select a target face region from the one or more face regions; a target image obtaining submodule, configured to correct the target face region to obtain the target face image.

In an embodiment, the target region obtaining submodule includes: a first determining unit, configured to, in response to determining that there is one face region, determine the face region as the target face region; a second determining unit, configured to, in response to determining that there are a plurality of face regions, for each of the plurality of face regions, calculate a score for the face region according to region parameter data of the face region, where the score is used to represent proximity of the face region to a medial axis of the original image; and determine a face region with a maximum score as the target face region.

In an embodiment, the region parameter data includes data of a length, a width, a face area, and a position. The second determining unit includes: an absolute value obtaining subunit, configured to obtain a difference between a horizontal coordinate of a center of the face region and half of a width of the face region, and an absolute value of the difference; a ratio obtaining subunit, configured to obtain a ratio of the absolute value of the difference to the width, and a product of the ratio and a constant 2; a product obtaining subunit, configured to obtain a difference between a constant 1 and the product, and obtain a product of the difference corresponding to the product and a preset distance weight; a square root obtaining subunit, configured to obtain a ratio of a face area of the face region to a product of a length of the face region and a width of the face region, and a square root of the ratio corresponding to the face area; a product obtaining subunit, configured to obtain a product of the square root and a preset area weight, where a sum of the preset area weight and the preset distance weight is 1; a score obtaining subunit, configured to calculate a sum of the product corresponding to the preset area weight and the product corresponding to the preset distance weight, to obtain the score for the face region.

In an embodiment, the target image obtaining submodule includes a candidate region obtaining unit, configured to determine a candidate square region corresponding to the target face region, to obtain vertex coordinate data of the candidate square region; an affine coefficient obtaining unit, configured to perform affine transformation on the vertex coordinate data of the candidate square region and vertex coordinate data of a preset square, to obtain an affine transformation coefficient, where the vertex coordinate data of the preset square includes a designated origin; an affine image obtaining unit, configured to perform affine transformation on the original image by the affine transformation coefficient, to obtain an affine-transformed image; a target image obtaining unit, configured to extract, by using the designated origin as a reference, a square region with a preset side length from the affine-transformed image, and determine an image in the square region as the target face image.

In an embodiment, the first coefficient obtaining module includes an image processing submodule, configured to separately blur and sharpen the target face image, to obtain one or more blurred images and one or more sharpened images; a feature image obtaining submodule, configured to separately extract feature data from the target face image, each of the one or more blurred images, and each of the one or more sharpened images, to obtain an original feature image, a blurred feature image, and a sharpened feature image; an initial image obtaining submodule, configured to concatenate the original feature image, the blurred feature image, and the sharpened feature image, to obtain an initial feature image; a target image obtaining submodule, configured to obtain an importance coefficient of each of feature images in the initial feature image for presenting an expression of the virtual character, and according to the importance coefficient, adjust the initial feature image, to obtain the target feature image; a face coefficient obtaining submodule, configured to, according to the target feature image, determine the template expression coefficient and the pose coefficient, to obtain the first face coefficient.

In an embodiment, the first coefficient obtaining module includes a first coefficient obtaining submodule, configured to input the target face image into a preset face coefficient recognition network, to obtain the first face coefficient for the target face image output by the preset face coefficient recognition network.

In an embodiment, the preset face coefficient recognition network includes: a blurring and sharpening module, a feature extracting module, an attention module, and a coefficient learning module; where the blurring and sharpening module is configured to respectively blur and sharpen the target face image, to obtain one or more blurred images and one or more sharpened images; the feature extracting module is configured to respectively extract feature data from the target face image, each of the one or more blurred images, and each of the one or more sharpened images, to obtain an original feature image, a blurred feature image, and a sharpened feature image; and concatenate the original feature image, the blurred feature image, and the sharpened feature image, to obtain an initial feature image; the attention module is configured to obtain an importance coefficient of each of feature images in the initial feature image for presenting an expression of the virtual character, and according to the importance coefficient, adjust the initial feature image, to obtain the target feature image; and the coefficient learning module is configured to determine, according to the target feature image, the template expression coefficient and the pose coefficient, to obtain the first face coefficient.

In an embodiment, the attention module is implemented by a network model of temporal attention mechanism or spatial attention mechanism.

In an embodiment, the coefficient learning module is implemented by one or more of: a Resnet50 network model, a Resnet18 network model, a Resnet100 network model, a DenseNet network model, or a YoloV5 network model.

In an embodiment, the target coefficient obtaining module includes: a weight coefficient obtaining submodule, configured to obtain a first face coefficient and a preset weight coefficient of a previous frame before the original image, where a sum of the preset weight coefficient of the previous frame and a preset weight coefficient of the original image is 1; a target coefficient obtaining submodule, configured to calculate a weighted sum of the first face coefficient of the original image and the first face coefficient of the previous frame, to obtain the target face coefficient for the original image.

In an embodiment, the apparatus further includes: an adaptation matrix obtaining module, configure to obtain a preset expression adaptation matrix, where the expression adaptation matrix indicates a transformation relationship between two face coefficients containing different numbers of templates; a target coefficient obtaining module, configured to calculate a product of a time-domain corrected face coefficient and the preset expression adaptation matrix, to obtain the target face coefficient.

In an embodiment, the preset expression adaptation matrix is obtained by: obtaining a first preset coefficient corresponding to a sample image, where the first preset coefficient includes coefficients for a first number of templates; obtaining a second preset coefficient corresponding to a sample image, where the second preset coefficient includes coefficients for a second number of templates; and according to the first preset coefficient, the second preset coefficient, and least squares, obtaining the preset expression adaptation matrix.

In an embodiment, the expression animation obtaining module is further configured to: in response to determining that no face region is detected in the original image, continue to detect a next original image, and according to the target face coefficient for the previous original image, obtain the virtual expression; or, in response to determining that no face region is detected in the original image and a duration exceeds a set threshold, obtain the virtual expression according to a preset expression coefficient.

It should be noted that the content of the apparatus embodiments in the present disclosure match the content of the above method embodiments, and can refer to the content of the above method embodiments, which is not repeated here.

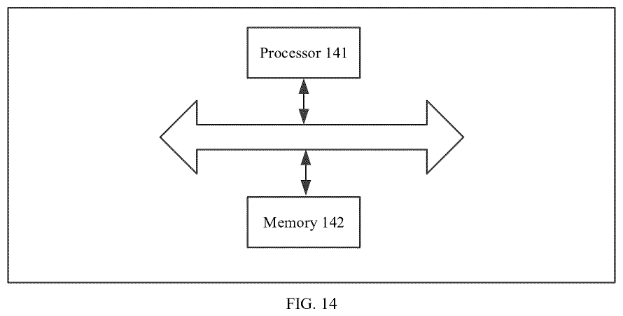

In some embodiments, an electronic device is further provided, as shown in FIG. 14, including: a processor 141; a memory 142 for storing computer programs that can be executed by the processor. The processor is configured to execute computer programs in the memory to implement the methods described in FIGS. 1 to 12.

In embodiments, a non-transitory computer-readable storage medium is further provided, such as a memory including executable computer programs that can be executed by a processor to implement the methods of the embodiments shown in FIGS. 1 to 12. The readable storage medium may be a Read-Only Memory (ROM), a Random Access Memory (RAM), a CD-ROM, a magnetic tape, a floppy disk and an optical data storage device, etc.

After considering and practicing the disclosure of the specification, other embodiments of the present disclosure will be readily apparent to those skilled in the art. The present disclosure is intended to cover any modification, use or adaptation of the present disclosure. These modifications, uses or adaptations follow the general principles of the present disclosure and include common knowledge and conventional technical means in the technical field that are not disclosed in the present disclosure. The specification and embodiments herein are intended to be illustrative only and the real scope and spirit of the present disclosure are indicated by the following claims of the present disclosure.

It is to be understood that the present disclosure is not limited to the precise structures described above and shown in the accompanying drawings and may be modified or changed without departing from the scope of the present disclosure. The scope of protection of the present disclosure is limited only by the appended claims.

1. A method for generating a virtual expression, comprising:
obtaining a face region in an original image to obtain a target face image;
obtaining a first face coefficient for the target face image, wherein the first face coefficient comprises a template expression coefficient and a pose coefficient, wherein the template expression coefficient is used to represent a degree of matching between a facial expression and each of one or more templates, and the pose coefficient is used to represent a rotation angle of a virtual character in three dimensions;
performing time-domain correction on the template expression coefficient and/or the pose coefficient of the first face coefficient, to obtain a target face coefficient, wherein the target face coefficient is associated with a face coefficient for a previous original image before the original image; and
according to the target face coefficient, rendering an expression of the virtual character, to obtain the virtual expression.

2. The method according to claim 1, wherein obtaining the face region in the original image to obtain the target face image comprises:
performing face detection on the original image, to obtain one or more face regions in the original image;
selecting a target face region from the one or more face regions; and
correcting the target face region to obtain the target face image.

3. The method according to claim 2, wherein selecting the target face region from the one or more face regions comprises:
in response to determining that there is one face region, determining the face region as the target face region;
in response to determining that there are a plurality of face regions, for each of the plurality of face regions, calculating a score for the face region according to region parameter data of the face region, wherein the score is used to represent proximity of the face region to a medial axis of the original image; and
determining a face region with a maximum score as the target face region.

4. The method according to claim 3, wherein the region parameter data comprises data of a length, a width, a face area, and a position, and for each of the plurality of face regions, calculating the score for the face region according to the region parameter data of the face region comprises:
for each of the plurality of face regions,
obtaining a first difference between a horizontal coordinate of a center of the face region and half of a width of the face region, and an absolute value of the first difference;
obtaining a first ratio of the absolute value of the first difference to the width, and a first product of the first ratio and a constant 2;
obtaining a second difference between a constant 1 and the first product, and obtaining a second product of the second difference and a preset distance weight;
obtaining a second ratio of a face area of the face region to a product of a length of the face region and a width of the face region, and a square root of the second ratio;
obtaining a third product of the square root and a preset area weight, wherein a sum of the preset area weight and the preset distance weight is 1; and
calculating a sum of the third product and the second product, to obtain the score for the face region.

5. The method according to claim 2, wherein correcting the target face region to obtain the target face image comprises:
determining a candidate square region corresponding to the target face region, to obtain vertex coordinate data of the candidate square region;
performing affine transformation on the vertex coordinate data of the candidate square region and vertex coordinate data of a preset square, to obtain an affine transformation coefficient, wherein the vertex coordinate data of the preset square comprises a designated origin;
performing affine transformation on the original image by the affine transformation coefficient, to obtain an affine-transformed image; and
extracting, by using the designated origin as a reference, a square region with a preset side length from the affine-transformed image, and determining an image in the square region as the target face image.

6. The method according to claim 1, wherein obtaining the first face coefficient for the target face image comprises:
separately blurring and sharpening the target face image, to obtain one or more blurred images and one or more sharpened images;
separately extracting feature data from the target face image, each of the one or more blurred images, and each of the one or more sharpened images, to obtain an original feature image, a blurred feature image, and a sharpened feature image;
concatenating the original feature image, the blurred feature image, and the sharpened feature image, to obtain an initial feature image;
obtaining an importance coefficient of each of feature images in the initial feature image for presenting an expression of the virtual character, and according to the importance coefficient, adjusting the initial feature image, to obtain a target feature image; and
according to the target feature image, determining the template expression coefficient and the pose coefficient, to obtain the first face coefficient.

7. The method according to claim 1, wherein obtaining the first face coefficient for the target face image comprises:
inputting the target face image into a preset face coefficient recognition network, to obtain the first face coefficient for the target face image output by the preset face coefficient recognition network.

8. The method according to claim 7, wherein the preset face coefficient recognition network comprises: a blurring and sharpening module, a feature extracting module, an attention module, and a coefficient learning module; wherein
the blurring and sharpening module is configured to respectively blur and sharpen the target face image, to obtain one or more blurred images and one or more sharpened images;
the feature extracting module is configured to respectively extract feature data from the target face image, each of the one or more blurred images, and each of the one or more sharpened images, to obtain an original feature image, a blurred feature image, and a sharpened feature image; and concatenate the original feature image, the blurred feature image, and the sharpened feature image, to obtain an initial feature image;
the attention module is configured to obtain an importance coefficient of each of feature images in the initial feature image for presenting an expression of the virtual character, and according to the importance coefficient, adjust the initial feature image, to obtain a target feature image; and
the coefficient learning module is configured to determine, according to the target feature image, the template expression coefficient and the pose coefficient, to obtain the first face coefficient.

9. The method according to claim 8, wherein the attention module is implemented by a network model of temporal attention mechanism or spatial attention mechanism.

10. The method according to claim 8, wherein the coefficient learning module is implemented by one or more of: a Resnet50 network model, a Resnet18 network model, a Resnet100 network model, a DenseNet network model, or a YoloV5 network model.

11. The method according to claim 1, wherein performing the time-domain correction on the template expression coefficient and/or the pose coefficient of the first face coefficient, to obtain the target face coefficient comprises:
obtaining a first face coefficient and a preset weight coefficient of a previous frame before the original image, wherein a sum of the preset weight coefficient of the previous frame and a preset weight coefficient of the original image is 1; and
calculating a weighted sum of the first face coefficient of the original image and the first face coefficient of the previous frame, to obtain the target face coefficient for the original image.

12. The method according to claim 1, wherein after performing the time-domain correction on the template expression coefficient and/or the pose coefficient of the first face coefficient, the method further comprises:
obtaining a preset expression adaptation matrix, wherein the expression adaptation matrix indicates a transformation relationship between two face coefficients containing different numbers of templates; and
calculating a product of a time-domain corrected face coefficient and the preset expression adaptation matrix, to obtain the target face coefficient.

13. The method according to claim 12, wherein the preset expression adaptation matrix is obtained by:
obtaining a first preset coefficient corresponding to a sample image, wherein the first preset coefficient comprises coefficients for a first number of templates;
obtaining a second preset coefficient corresponding to a sample image, wherein the second preset coefficient comprises coefficients for a second number of templates; and
according to the first preset coefficient, the second preset coefficient, and least squares, obtaining the preset expression adaptation matrix.

14. The method according to claim 1, further comprising:
in response to determining that no face region is detected in the original image, continuing to detect a next original image; and according to the target face coefficient for the previous original image, obtaining the virtual expression; or,
in response to determining that no face region is detected in the original image and a duration exceeds a set threshold, obtaining the virtual expression according to a preset expression coefficient.

15. (canceled)

16. An electronic device, comprising:
one or more processors; and
one or more memories storing executable instructions;
wherein the one or more processors read the executable instructions from the one or more memories to implement a method for generating a virtual expression, wherein the method comprises:
obtaining a face region in an original image to obtain a target face image;
obtaining a first face coefficient for the target face image, wherein the first face coefficient comprises a template expression coefficient and a pose coefficient, wherein the template expression coefficient is used to represent a degree of matching between a facial expression and each of one or more templates, and the pose coefficient is used to represent a rotation angle of a virtual character in three dimensions;
performing time-domain correction on the template expression coefficient and/or the pose coefficient of the first face coefficient, to obtain a target face coefficient, wherein the target face coefficient is associated with a face coefficient for a previous original image before the original image; and
according to the target face coefficient, rendering an expression of the virtual character, to obtain the virtual expression.

17. A chip, comprising:
one or more processors; and
one or more memories storing an executable program;
wherein the one or more processors read the executable program from the one or more memories to implement a method for generating a virtual expression, wherein the method comprises:
obtaining a face region in an original image to obtain a target face image;
obtaining a first face coefficient for the target face image, wherein the first face coefficient comprises a template expression coefficient and a pose coefficient, wherein the template expression coefficient is used to represent a degree of matching between a facial expression and each of one or more templates, and the pose coefficient is used to represent a rotation angle of a virtual character in three dimensions;
performing time-domain correction on the template expression coefficient and/or the pose coefficient of the first face coefficient, to obtain a target face coefficient, wherein the target face coefficient is associated with a face coefficient for a previous original image before the original image; and
according to the target face coefficient, rendering an expression of the virtual character, to obtain the virtual expression.

18. A non-transitory computer-readable storage medium storing a computer-executable program, wherein when the computer-executable program is executed, the method according to claim 1 is implemented.

19. The electronic device according to claim 16, wherein obtaining the face region in the original image to obtain the target face image comprises:
performing face detection on the original image, to obtain one or more face regions in the original image;
selecting a target face region from the one or more face regions; and
correcting the target face region to obtain the target face image.

20. The electronic device according to claim 19, wherein selecting the target face region from the one or more face regions comprises:
in response to determining that there is one face region, determining the face region as the target face region;
in response to determining that there are a plurality of face regions, for each of the plurality of face regions, calculating a score for the face region according to region parameter data of the face region, wherein the score is used to represent proximity of the face region to a medial axis of the original image; and
determining a face region with a maximum score as the target face region.

21. The electronic device according to claim 20, wherein the region parameter data comprises data of a length, a width, a face area, and a position, and for each of the plurality of face regions, calculating the score for the face region according to the region parameter data of the face region comprises:
for each of the plurality of face regions,
obtaining a first difference between a horizontal coordinate of a center of the face region and half of a width of the face region, and an absolute value of the first difference;
obtaining a first ratio of the absolute value of the first difference to the width, and a first product of the first ratio and a constant 2;
obtaining a second difference between a constant 1 and the first product, and obtaining a second product of the second difference and a preset distance weight;
obtaining a second ratio of a face area of the face region to a product of a length of the face region and a width of the face region, and a square root of the second ratio;
obtaining a third product of the square root and a preset area weight, wherein a sum of the preset area weight and the preset distance weight is 1; and
calculating a sum of the third product and the second product, to obtain the score for the face region.
